(19) United States
(12) Patent Application Publication
(10) Pub. No.: US 2019/0337713 A1
(43) Pub. Date: Nov. 7, 2019

(54) SINGLE-SERVING SELF-PIERCING POD FOR LIQUID AND POWDERED AND GRANULAR BEVERAGE CONCENTRATES

(71) Applicant: WHIRLPOOL CORPORATION, Benton Harbor, MI (US)

(72) Inventors: Erdogan Ergican, St. Joseph, MI (US); Sann Naing, St. Joseph, MI (US)

(21) Appl. No.: 16/474,453

(22) PCT Filed: Dec. 29, 2017
(86) PCT No.: PCT/US2017/069044

§ 371 Date: Jun. 27, 2019

Related U.S. Application Data
(60) Provisional application No. 62/440,986, filed on Dec. 30, 2016.

(51) Int. Cl. B65D 85/804; A47J 31/40; A47J 31/44; B65D 85/72; B65D 17/00

(52) U.S. Cl. CPC B65D 85/8043; A47J 31/407; B65D 2221/00; B65D 85/72; B65D 17/02; A47J 31/4482

(57) ABSTRACT

A single-serving capsule holding liquid and powdered beverage concentrates and dispensing systems/machines related thereto. The capsule is self-piercing and does not require a mechanical device to create water fluid inlet and fluid outlet openings in the capsule. The capsule can be used to make both hot and cold beverages.

### CROSS-REFERENCE TO RELATED APPLICATION

This application is a National Phase entry of PCT/US2017/069044, filed on Dec. 29, 2017 and entitled “SINGLE-SERVING SELF-PIERCING POD FOR LIQUID AND POWDERED AND GRANULAR BEVERAGE CONCENTRATES”, the entire disclosure of which is hereby incorporated by reference. International Application No. PCT/US2017/069044 claims priority to U.S. Provisional Patent Application No. 62/440,986, filed Dec. 30, 2016, entitled “SINGLE-SERVING SELF-PIERCING POD FOR LIQUID AND POWDERED AND GRANULAR BEVERAGE CONCENTRATES,” the disclosure of which is hereby incorporated by reference in its entirety.

### BACKGROUND

Single-serve beverages have become increasingly popular in the last few years. While concentrated drink mixes have been available to consumers for years, more recently, products providing hot, filtered coffee and tea from a single-serve container are becoming increasingly popular. These products are often produced using a machine that can pierce the single-serve container at the top and bottom, and then feed hot water through the container to create the hot beverage.

One type of single-serve container is as simple as providing a concentrate in a container or sleeve with only enough concentrate for a single use. The concentrate, which most often come in a dry powder or granular form, can then be manually mixed with hot water to create the hot beverage. Such containers have several disadvantages, including lower quality taste and the need for a separate device to provide boiling or hot water.

Powders and other concentrates are also available to provide cold drinks. These products are also available in single-serve and multiple serving sized containers. The products typically come in a dry powder, but liquid concentrates are also available. However, these products are undesirable because after manual mixing with water, the concentrate is often left incompletely or non-uniformly distributed, negatively affecting taste and texture.

A third type of self-serve container is the KEURIG® type capsule that is made to be used in a specific machine. The KEURIG® type capsules contain concentrate, tea, or coffee grounds and have a filter at the outlet end. The machine punctures these single-serving containers at the top and bottom, then water flows through the capsule to make the beverage. This type of container requires the machine to mechanically puncture the capsule, which may be unsanitary. Also, the KEURIG® type of single-serving container does not guarantee good mixing control or sealing between the device and the capsule.

### SUMMARY

One aspect of the present disclosure includes a single-serve capsule that may be used in a device to produce a hot or cold beverage. Hot or cold water may flow into and out of the capsule through an inlet and then an outlet to make the beverage. The capsule may be self-piercing, such that no piece of the device enters or directly punctures the capsule. Instead, pressure on the capsule may cause designed weak points to break, creating an inlet and an outlet.

An aspect of the present disclosure is generally directed toward a single-serving beverage capsule that includes: a capsule body having an interior space between an inside of the capsule body and a composite film, the composite film attached to the capsule body at a capsule body bottom perimeter to create a sealed composite film and where the sealed composite film includes at least one weak point is located about a composite film perimeter and in substantially the same plane as the composite film, the at least one weak point configured to break under a pressure less than the pressure needed to break a non-weak point portion of the sealed composite film and open a flow channel without the use of a physical piercing member that allows a beverage concentrate to flow through at least one of the at least one weak points and into the interior space; a capsule cap having an exterior side and an interior side and having a capsule cap perimeter that is substantially equal to a perimeter of the composite film and the perimeter of the capsule body, the capsule cap being attached to a bottom end of the capsule body with the composite film between the interior side of the capsule cap and the bottom end of the capsule body and having a flow channel directing to a flow channel outlet; and a distributor engaged with the capsule cap and having a water inlet, the flow channel outlet and a beverage outlet attached to the bottom side of the capsule cap.

Yet another aspect of the present disclosure is generally directed toward a single-serving beverage concentrate containing capsule that includes: a capsule body having a first composite film attached to a top perimeter at a top end of the capsule body such that the first composite film is attached about on entirety of the top perimeter and a beverage concentrate is within the capsule body when the capsule is unused; at least one weak point in an attachment interface of the first composite film and the top perimeter, where the at least one weak point is located about a perimeter of the first composite film and the at least one weak point is formed as a part of the first composite film and the at least one weak point is configured to break under pressure prior to at least one strong attachment area that has more radial surface area of the first composite film attached to the top perimeter than a radial surface area of the first composite film attached to the top perimeter that forms the at least one weak point; and a capsule cap attached to a bottom perimeter of the capsule body.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1A is a top perspective view of the capsule according to an aspect of the present disclosure.

FIG. 1B is a bottom perspective view of the capsule shown in FIG. 1.

FIG. 2 is an exploded view of the capsule shown in FIGS. 1A and 1B.

FIG. 3 is a top view of the capsule shown in FIG. 1A.

FIG. 4 is a bottom view of the capsule shown in FIG. 1A, but having two finger receiving wings instead of one.

FIG. 5 is an enlarged section view of the portion of the capsule shown in FIG. 4 identified by line A-A with an enlarged section view of the channel and sharp edges.

FIG. 6 is a cross-sectional view taken along line VI-VI in FIG. 4.

FIG. 7 is an enlarged view of section B-B in FIG. 6.

FIG. 8 is a perspective view of a capsule according to another embodiment of the present disclosure.

FIG. 9 is an exploded of the capsule shown in FIG. 8.

FIG. 10 is a top view of the capsule shown in FIG. 8 with the composite film removed.

FIG. 11 is a bottom view of the capsule shown FIG. 8.

FIG. 12 is an enlarged view of the center section of FIG. 11 shown in dot-dashed lines in FIG. 11.

FIG. 13 is a cross-sectional view taken along lines XIII-XIII in FIG. 11.

FIG. 14 is an enlarged view of the piercing mechanism of FIG. 13.

FIG. 15 is a perspective view of a capsule according to yet another embodiment.

FIG. 16 is an exploded view of the capsule shown in FIG. 15.

FIG. 17A is an enlarged perspective view of the inside of the capsule cap of the capsule shown in FIG. 15.

FIG. 17B is an enlarged perspective view of the inside of the capsule cap of the capsule shown in FIG. 15 with the center diaphragm extended upward.

FIG. 18 is a top view of the capsule shown in FIG. 15 with the top composite film partially removed.

FIG. 19 is a top view of the capsule shown in FIG. 15 with the top composite film completely removed.

FIG. 20 is a cross-section view of the capsule shown in FIG. 15 taken along line XX-XX.

FIG. 21 is a perspective view of the front side of a collapsible pod mechanism according to an embodiment.

FIG. 22 is an exploded view of the collapsible pod mechanism shown in FIG. 21.

FIG. 23 is an enlarged perspective and partially exploded view of the gear box assembly of the collapsible pod mechanism shown in FIG. 21.

FIG. 24 is a perspective view of the front side of a piston pod mechanism according to an embodiment.

FIG. 25 is an exploded view of the piston pod mechanism shown in FIG. 24.

FIG. 26 is a cross-section view of the manifold assembly of the piston pod mechanism shown in FIG. 24 taken along lines XXVI-XXVI in FIG. 27.

FIG. 27 is an enlarged bottom perspective view of the manifold assembly of the piston pod mechanism shown in FIG. 24.

FIG. 28 is an enlarged, exploded perspective view of the removable insert of the piston pod mechanism shown in FIG. 24.

FIG. 29 is an enlarged, exploded perspective view of the drawer open/close module of the piston pod mechanism shown in FIG. 24.

FIG. 30 is an enlarged exploded perspective view of the optical reader of the piston pod mechanism shown in FIG. 24.

### DETAILED DESCRIPTION

Before the present disclosure is described further, it is to be understood that the present disclosure is not limited to the particular embodiments of the disclosure described below, as variations of the particular embodiments may be made and still fall within the scope of the appended claims. It is also to be understood that the terminology employed is for the purpose of describing particular embodiments/aspects, and is not intended to be limiting. Instead, the scope of the present disclosure will be established by the appended claims. It is to be further understood that all embodiments, variations, and combinations described herein are enabled by this disclosure.

Where a range of values is provided, it is understood that each intervening value, to the tenth of the unit of the lower limit unless the context clearly dictates otherwise, between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure.

In this specification and the appended claims, the singular forms “a,” “an” and “the” include plural reference unless the context clearly dictates otherwise.

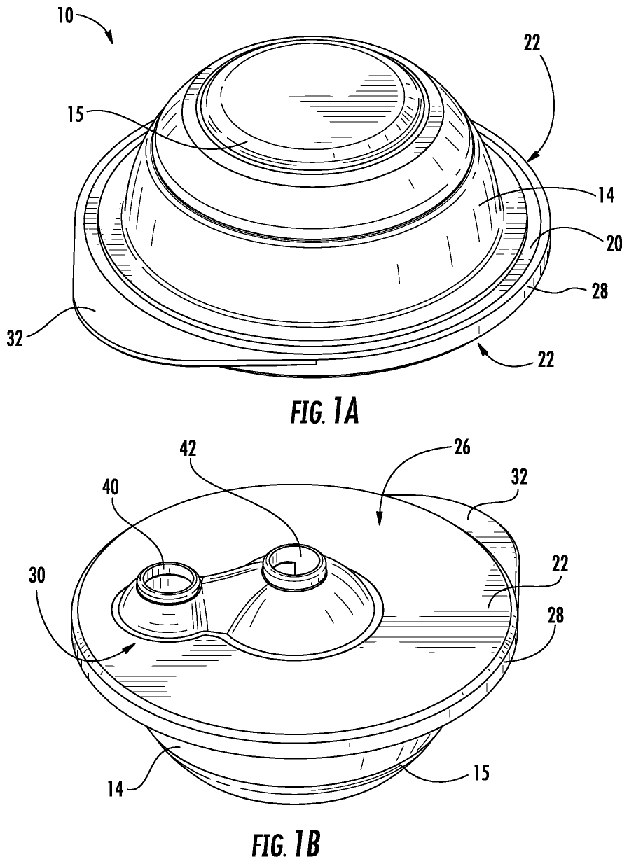

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

### Collapsible Pod

Referring to FIGS. 1A and 1B, reference numeral 10 designates collapsible pod with capsule body 14 and capsule cap 22. The capsule body 14 may have a generally frustoconical shape, as shown in FIGS. 1A and 1B, and may be made of plastic or polymer material, but this disclosure could apply to any number of materials and shapes. Ridge-like features 15 on capsule body 14 act as a collapsible mechanism, enabling the body to fold into a flattened shape when compressed. The ridge-like features 15 provide an area around the perimeter of capsule body 14 where the material making up capsule body 14 may fold onto itself, allowing the capsule body to flatten when compressed and expel all the concentrate or powder material therein. Capsule cap 22 may have wing(s) 32 at the sides of capsule cap 22. FIGS. 1A and 1B show only one wing, however multiple wings may also be used. Wing(s) 32 allow users to easily and facilitate insertion and removal of the pods from a mechanism used in connection with the pod. In addition, the wings may provide a profile that may mate with a cutout in the mechanism, guaranteeing that the pod is correctly and securely loaded to prevent leakage and the mechanism will function properly. The mechanism is typically positioned within an appliance such as a refrigerator or is in an independent, oftentimes, countertop beverage dispensing appliance.

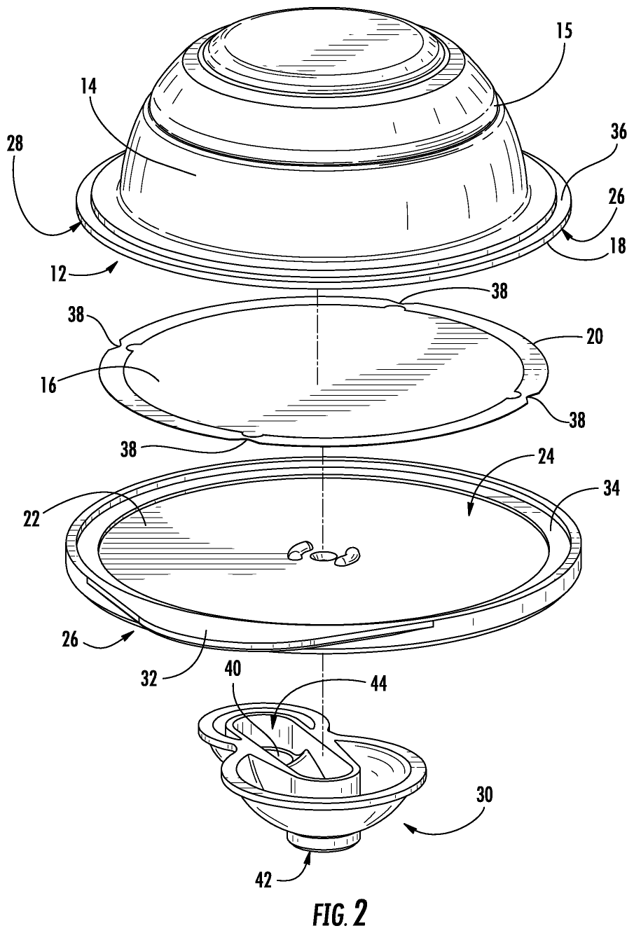

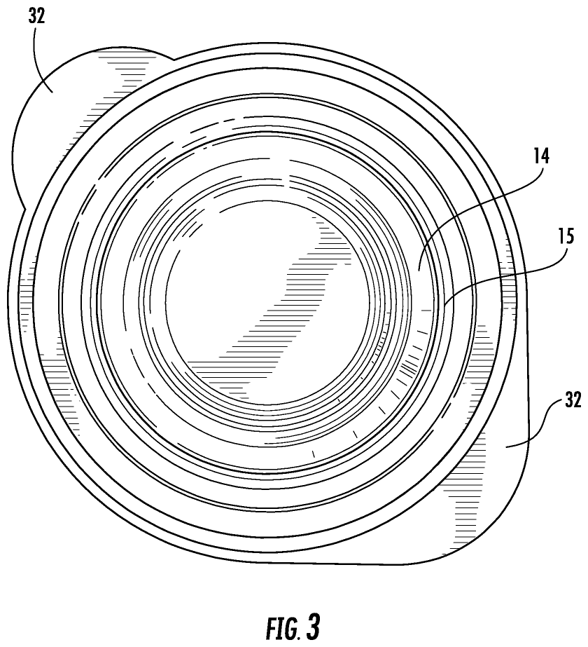

FIG. 1B shows distributor cap 30 at the bottom side of capsule cap 22. Distributor cap 30 may be made of plastic or polymer material and sonically welded to or integrally formed with the bottom of the capsule cap, but it should be known to those within the art that this disclosure could apply to any number of materials and attachment methods. Distributor cap 30 may have water inlet 40 and beverage outlet 42. Mixing space 44 (see FIG. 2) is located inside of distributor cap 30, between water inlet 40 and beverage outlet 42.

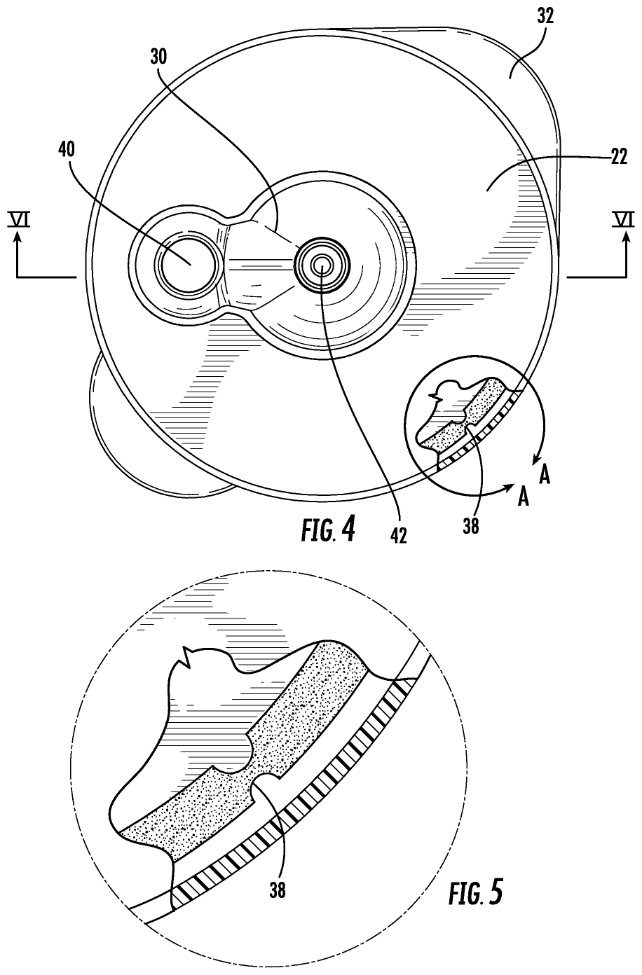

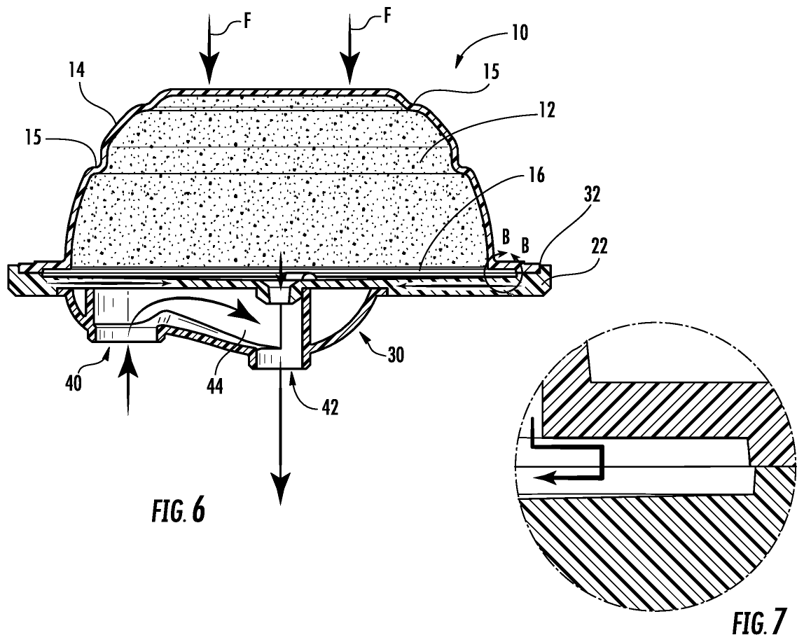

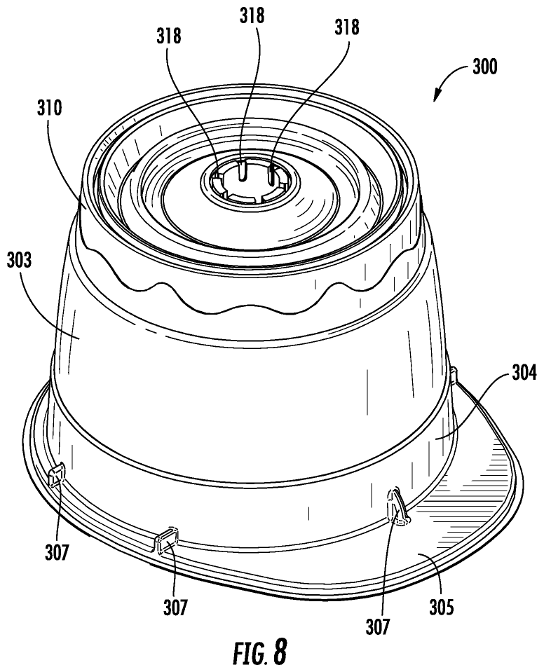

As shown in FIGS. 2-7, collapsible pod 10 may be include composite film 16 located between capsule body 14 and capsule cap top side 24. Composite film 16 may be heat staked to capsule body 14 at capsule body male lip 36, but any number of attachment methods may be used such as an adhesive attachment. Capsule cap female lip 34 fits over capsule body male lip 36 and capsule cap 22 may then be sonically welded to capsule body 14, but again any number of attachment methods such as adhesive attachments may be used. The attachment should create a liquid tight seal. Weak point(s) 38 may be located at composite film perimeter 28. A weak point 38 (See FIGS. 4-5)is an area or location along the liquid tight seal of the composite film that is designed to disengage from the capsule body before the other areas of the composite film that are not weak points disengage from the capsule body. Less liquid pressure or other force is needed to break a weak point than other areas where the film engages the capsule body. While the majority of the composite film will deform elastically under pressure, the weak point 38 is designed to break at a pressure less than the pressure at which the composite film will break. Interior space 12 exists between composite film 16 and capsule body 14 and may be filled with a beverage concentrate. As shown in FIGS. 6-7, as force is applied in a downward direction on the capsule body (shown with two parallel arrows F, the concentrate flows/moves around the perimeter after the weak points are broken (See FIG. 7) and mixed with water (or other potable liquid) flowing in the water inlet 40 into mixing space 44. Thereafter, the resultant beverage is dispensed from beverage outlet 42.

### Collapsible Pod Mechanism

As shown in FIGS. 21-23, a collapsible pod 10 may be loaded into collapsible pod mechanism 100. The collapsible pod mechanism typically includes motor 102, motor housing 104, main frame 106, drawer assembly 108, and gear box assembly 110. Gear box assembly 110 may have top housing 112 and bottom housing 114, with much of the parts that make up gear box assembly 110 fitting between those pieces. Top housing 112 and bottom housing 114 (see FIG. 23) may be constructed of metal, plastic, or polymer material, but it should be known to those within the art that any number of different materials may be used. Top housing 112 and bottom housing 114 may be matingly attached to one another by screws 113 or clips or other suitable attachment methods. Screws 113 may fit through eyelets 115 in top housing 112 and thread into threaded holes 117 in bottom housing 114. First microswitch 111 may be located toward a top side of gear box assembly top housing 112 and second microswitch 119 may be located toward a bottom end of gear box assembly top housing 112.

A top bearing 116 may sit above and bottom bearing 118 may sit below worm gear 120. Top bearing 116 and bottom bearing 118 may be used to reduce friction and provide smoother rotation of worm 122. Worm gear 120 may be rotatably engaged with worm 122, which may be attached between top housing 112 and bottom housing 114. Worm 122 may connect to top housing 112 and bottom housing 114 via bearing 126 in cutout 124 that is semicircle shaped to fit bearing 126 material; however, the cutout can be any shape so long as there is no interference with the rotation of worm 122. Shaft 130 may be attached to worm gear 120 at a first end and connected to interface bracket 136 and interface 138 at second end 134 via connection 140. Connection 140 may be a threaded or screw connection, but it should be known to those within the art that this disclosure could apply to any number of connections. The interface bracket 136 is typically circular shaped components as shown in FIG. 23. Interface 138 may have snap connections 142, which may fit over interface bracket 136 and may attach interface 138 to interface bracket 136 and shaft 130. Worm 122, worm gear 120, and shaft 130 may all be made of metal, plastic, alloy, or polymer material and top 116 and bottom 118 bearings may be constructed of a mixture of plastic, polymer, and metal for their component parts. Bearing 126 may provide advantages such as decreased friction between the worm 120 and gear box assembly 110.

Motor 102 may be integrally attached to motor housing 104. Motor 102 may be an electric motor or any other motor that is known in the art. Motor 102 may be connected to main frame 106 and may be connected using housing screw(s) 154. Motors are well known in the art and any such motor could be used in conjunction with the present disclosure. Motor 150 may be rotatably mated to worm 122. Motor 102 may have a multiple part cylindrical shape. The cylindrical shape provides space saving benefits over other designs and facilitates balanced rotation. Motor 102 may have a female hex motor drive connection 103 which may matingly engage with a male hex worm drive connection 105. Such an Allen drive may provide manufacturing and connectivity benefits over other drive connections known in the art.

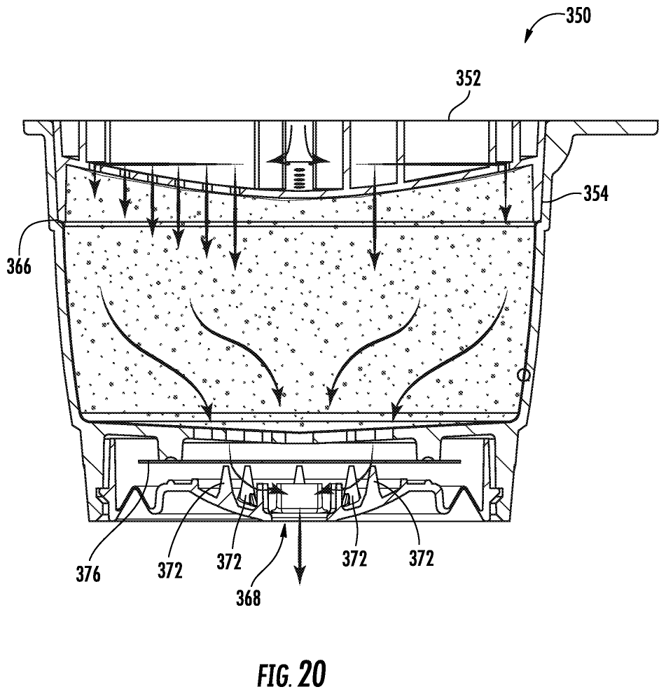

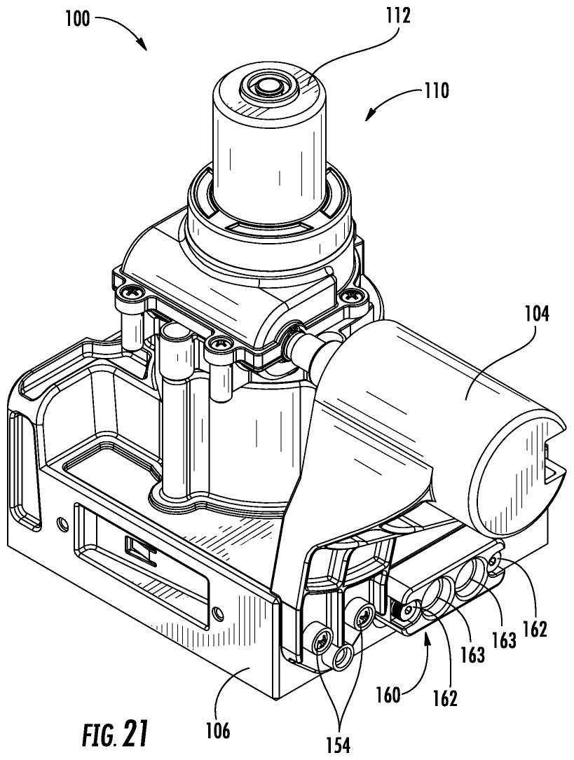

Water inlet adapter 160 (See FIG. 20) may be connected to main frame 106 and may be connected using adapter screw(s) 162. Water inlet adapter 160 may provide a mechanism through which water and other liquids, even air, may flow into collapsible pod mechanism 100. Water inlet adapter 160 may have protruding end 161 which may matingly engage with a main frame protruding end fitting (not shown). Inlet adapter gaskets 164 may attach to protruding end 161 providing a seal between water inlet adapter 160 and main frame 106.

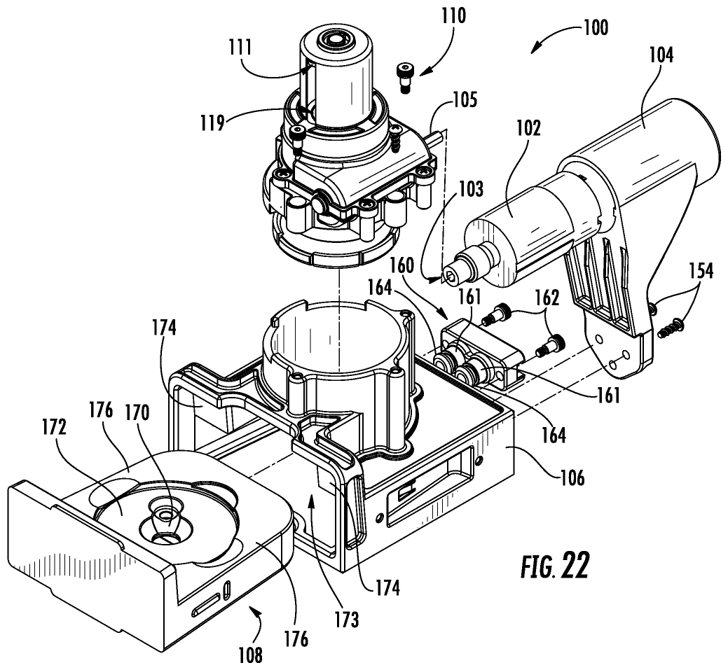

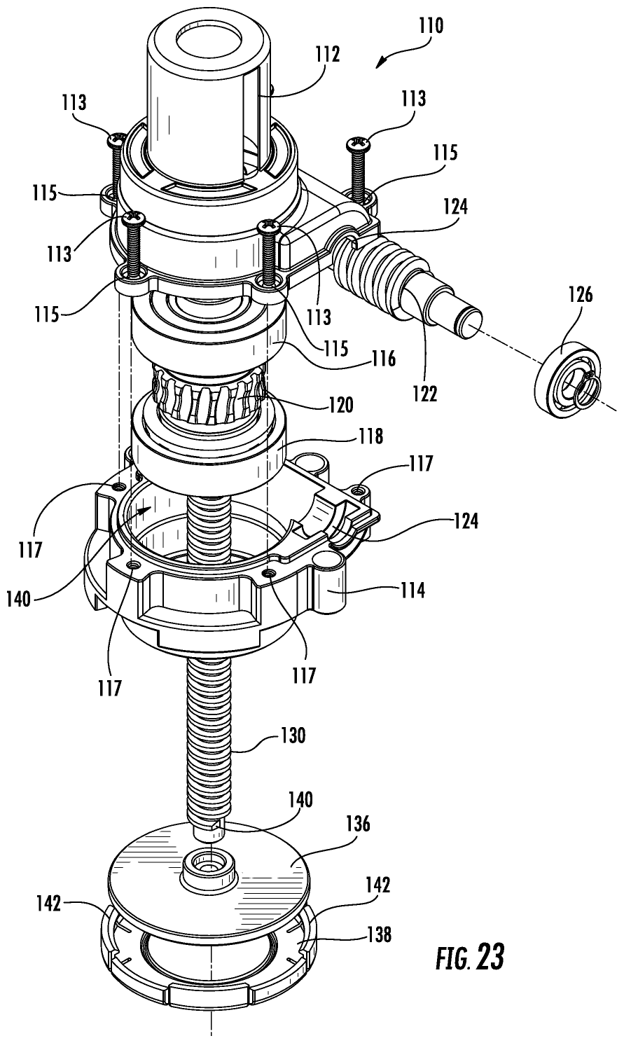

As shown in FIG. 22, drawer assembly 108 may have pod cutout 170, which may be configured to accept collapsible pod 10, typically in a mating fashion. Pod cutout 170 may be of substantially the same or the same corresponding shape as collapsible pod 10 or may use any other method known in the art to accept and engage collapsible pod 10. Interface cutout 172 may be configured to accept interface 138 and may be of substantially the same or the same shape as interface 138. Drawer assembly 108 may be configured to slidably engage with main frame 106. The drawer assembly may be completely removable from main frame or may slide out at least a majority of its depth, but enough to load a pod into the pod cutout 170. Main frame 106 may have side stays 174 which may engage with drawer assembly stays 176, preventing substantial movement of the drawer assembly 108 within main frame 106. A switch may be located in the drawer assembly slot 173 within the main frame 106 and may be in communication with a controller (not shown), which can be a printed circuit board, microprocessor or central processing unit (CPU).

A user may load a pod into drawer pod cutout 170 then push drawer assembly 108 into main frame 106. The microswitch (not shown) located within the drawer assembly slot 173 may detect the presence or absence of drawer assembly 108 within main frame 106 and may send a signal to the controller to turn on an optical reader when drawer assembly 108 positioned in the installed position within is main frame 106. Gasket (not shown) may create a seal between water inlet 40 of collapsible pod 10 and a waterway into drawer assembly 108. The water inlet adapter has two separate waterways 163 into the drawer assembly: the first may connect with water inlet 40 using fluid conduits; and the second may bypass pod 10 and dispense water directly or at least without having the water flow through the pod.

An optical reader may scan drawer assembly to identify the beverage selection, such as the type of pod present in drawer assembly 108. The Controller may then energize motor 102 which may turn worm 122. Worm 122 may have threads which may be rotatably connected to worm gear 120 which drives shaft 130 downwards until it closes second microswitch 119. The second microswitch being closed signifies signify that the gear box assembly is in an away position, a fact communicated to the controller.

Interface 138 may be attached to an end of shaft 130 and may come into contact with capsule body 14. Shaft 130 may be driven by gear box assembly 110 and may move at various speeds depending on the beverage selection identified by optical reader. When interface 138 comes into contact with capsule body 14, ridge-like features 15 cause capsule body 14 to collapse into a flat shape. While interface 138 driven by shaft 130 crushes capsule body 14, water may flow through collapsible pod distributor cap 30 and mix with beverage concentrate in mixing space 44. The beverage then flows out of beverage outlet 42 as shown in FIG. 6. When dispensing is complete, motor 102 may spin in reverse, retracting shaft 130 until it opens the second microswitch, and closes the first microswitch, signifying gear box assembly 110 is in the “home” position.

### Piston Pod

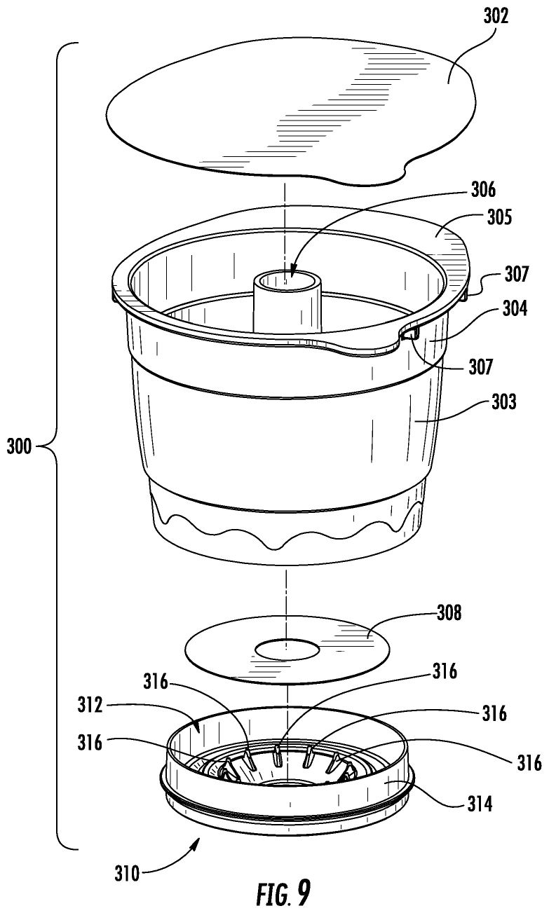

Referring generally to FIGS. 8-14, 300 designates a piston pod generally. Top composite film 302 is attached to a top perimeter side portion 304 of capsule body 303. The piston pod's top perimeter side portion is adjacent on outwardly extending lip 305 supported by integrated structural support projections 307 that engage the lip 305 and the top perimeter side portion 304 of the capsule body 303. The structural support projections 307 are typically spaced circumferentially about the capsule body to provide support for the outwardly extending lip 305. The structural support projections 307 may be any shape, but are generally archuous (arch-shaped) or substantially rectangular cuboidal shaped support with one surface engaging the tip and the other the top perimeter side portion 304.

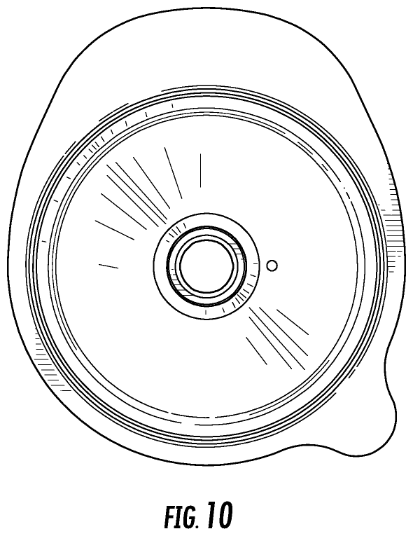

Center column 306 (See FIG. 9) may be attached to capsule body 303 or may be an integrated part of capsule body 303. Center column 306 may be a hollow tube that runs from just beneath top composite film, through capsule body 303 and through bottom composite film 308 to capsule cap 310. Center column 306 provides a direct path for liquid to flow through capsule body 303 without mixing with fluids. A direct flow method allows for better overflow rates and mixing rates as compared to other methods.

Bottom composite film 308 (See FIG. 9) may be attached to a bottom surface of capsule body 303. Top composite film 302 and bottom composite film 308 may be heat staked to capsule body 303, or may be attached with any other method known in the art. Heat staking provides some benefits over other methods of attaching materials because is it cost effective and provides reliable liquid-tight sealing. Capsule cap 310 may be sonically welded or snap fitted to capsule body 303, but it should be known to those within the art that this disclosure could apply to any number of attachment methods or the conceivably could be made as one integral piece. Capsule body 303 may have a generally frustoconical shape (see FIG. 8), and may be made of plastic or polymer material, but it should be known to those within the art that this disclosure could apply to any number of materials and shapes.

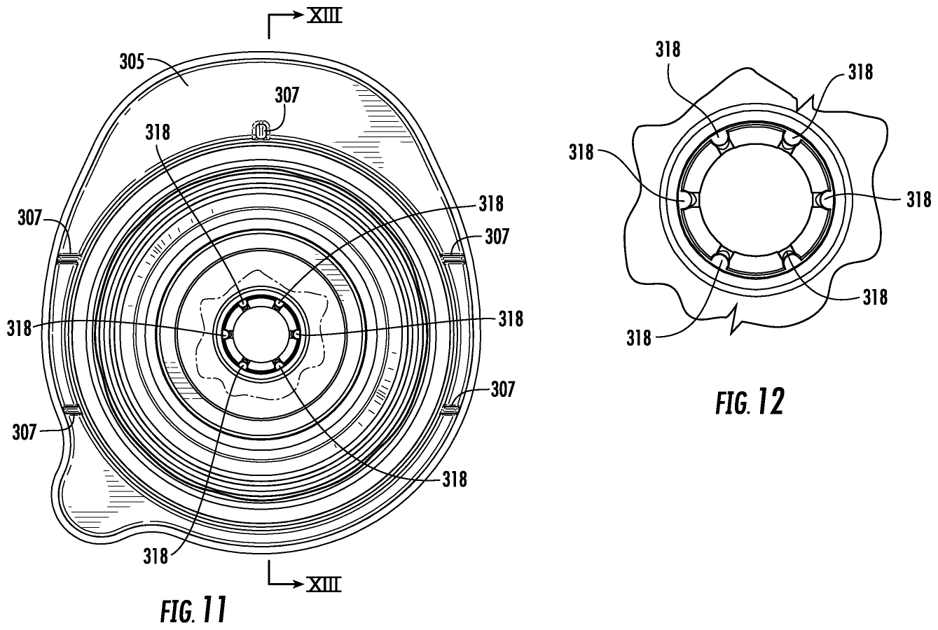

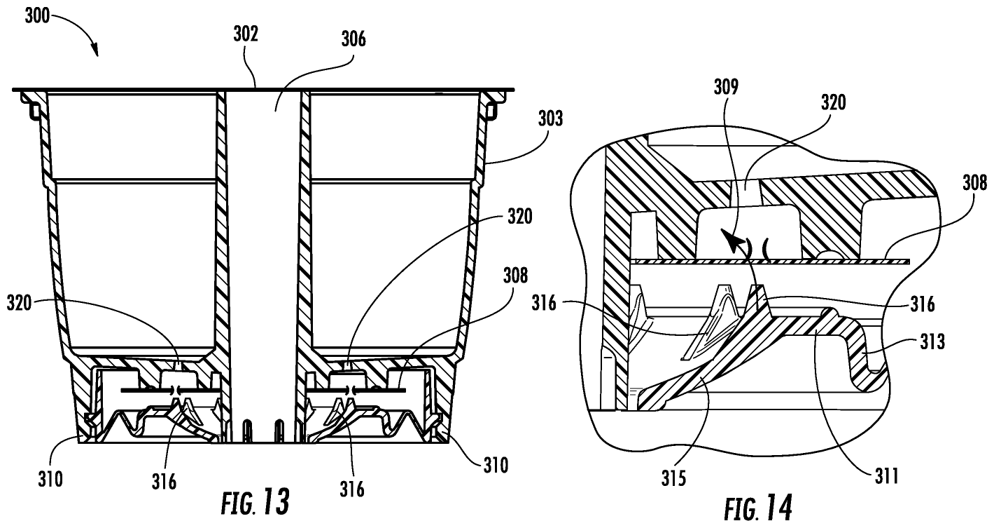

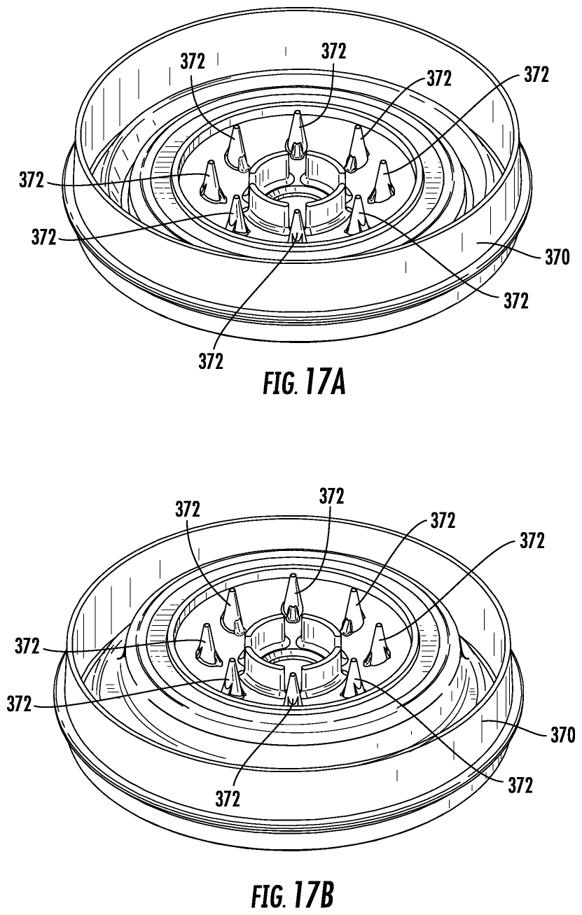

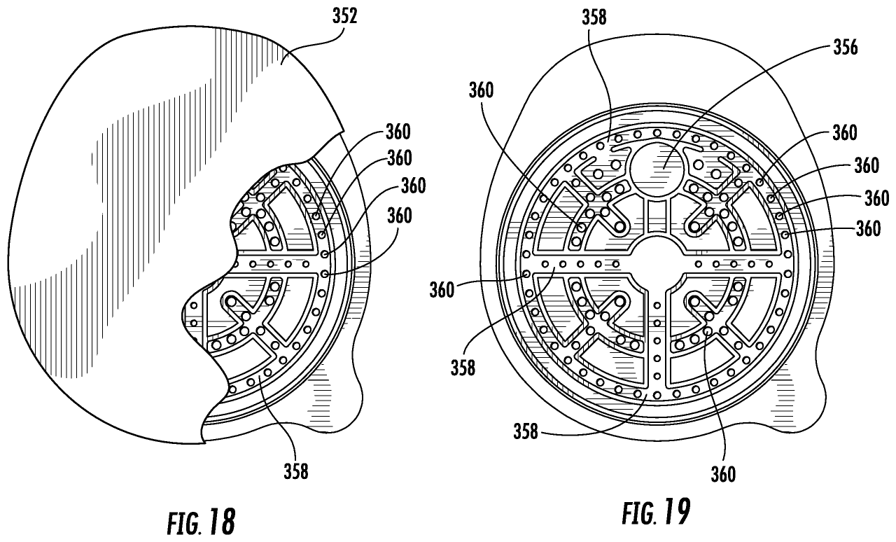

Capsule cap 310 may have an inner side 312 and an outer side 314. Inner side 312 may have spike(s) 316, which can be projections or inwardly extending members integrally formed with the diaphragms and outer side may have nozzle(s) 318 (See FIGS. 11-12). As shown in FIGS. 13 and 14, capsule cap 310 may flex inwardly, like a diaphragm (see FIGS. 13-14, 17A, and 17B), when a force is applied to the bottom surface of the outside side 314. After the force is applied to the outside side 314 of the capsule cap 30, sloped side 315 and flat side 311 are forced upward. As a result, spike 316 is forced toward bottom composite film 308 in a slightly archuous manner, bending away from the center. When capsule cap 310 flexes upward, spike(s) 316 creates incisions in bottom composite film 308 at arrow 309, which shows the direction of movement/force of the spike(s) 316. Capsule body 303 may be filled with a dry or liquid beverage concentrate, typically a liquid beverage concentrate, and when the spike(s) create incisions in bottom composite film, the liquid beverage concentrate may be released from within capsule body 303.

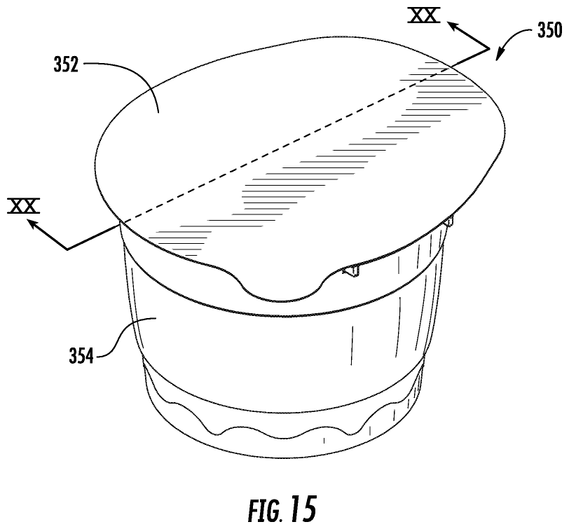

In another embodiment shown in FIGS. 15-20, a piston pod 350 may lack the center column 306 of the embodiment shown in FIGS. 8-14. Top composite film 352 may be attached to top cap 353 and/or capsule body 354. Top cap 353 may be attached to capsule body 354. Top composite film 352 and top cap 353 may be attached by heat staking the pieces together or an adhesive may be used to attach the composite film, but it should be known to those within the art that this disclosure could apply to any number of attachment methods.

As shown in FIGS. 18-19, top cap 353 may have recessed pocket 356, which may function to isolate an air nozzle from water backflow. Top cap 353 may also act to evenly distribute liquid across capsule body 354. In one embodiment, even distribution may be achieved by laying out channel(s) 358 within top cap 353. Channel(s) 358 may create flow paths which direct liquid to hole(s) 360. Hole(s) 360 may penetrate through top cap 353, allowing liquid to pass through hole(s) 360 into capsule body 354. As shown in FIG. 20, such a method of distributing liquid helps ensure an even distribution of the liquid into the capsule, which provides a higher quality beverage and lowers cost by decreasing the amount of concentrate, typically a powder concentrate, or grounds necessary to produce the beverage.

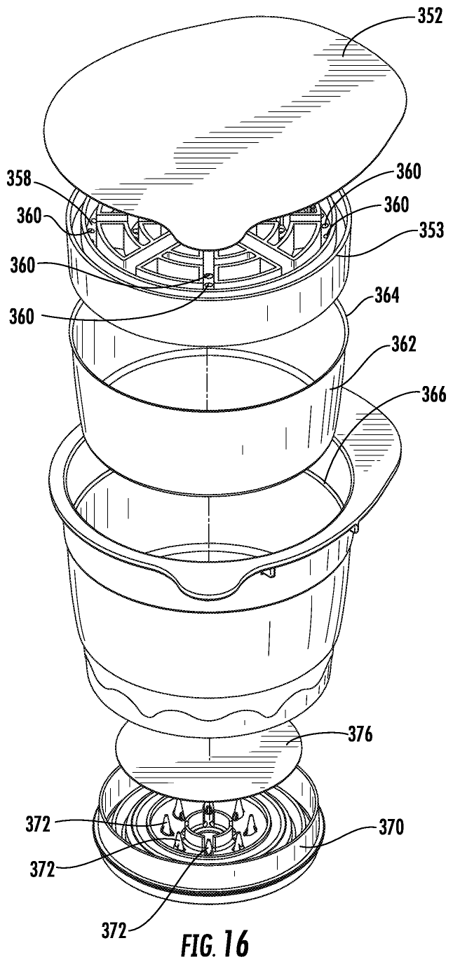

As shown in FIG. 16, filter 362 may be located within capsule body 354. Filter 362 may be lip attached to capsule body 354, wherein the bottom filter lip 364 mates with capsule body lip 366 and is held in place with top cap 353 resting on capsule body lip 366 to hold filter 362 in place. However, it should be known to those within the art that this disclosure could apply to any number of attachment methods. Filter 362 may prevent small particles from escaping capsule body 354 to ensure only liquid beverage escape through outlet 368.

### Piston Pod Mechanism

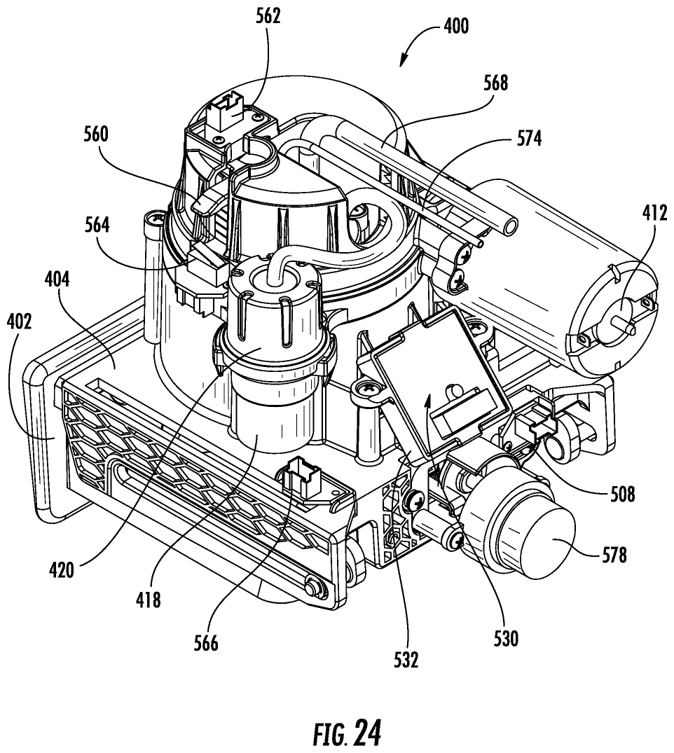

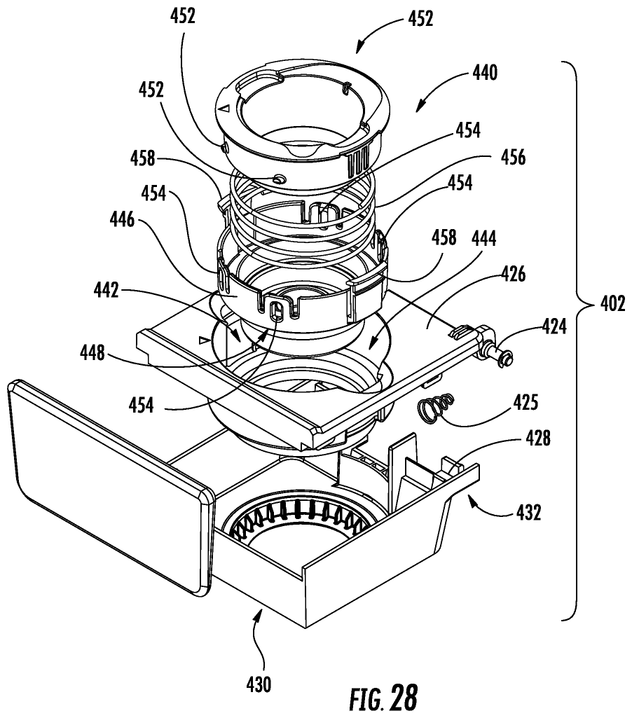

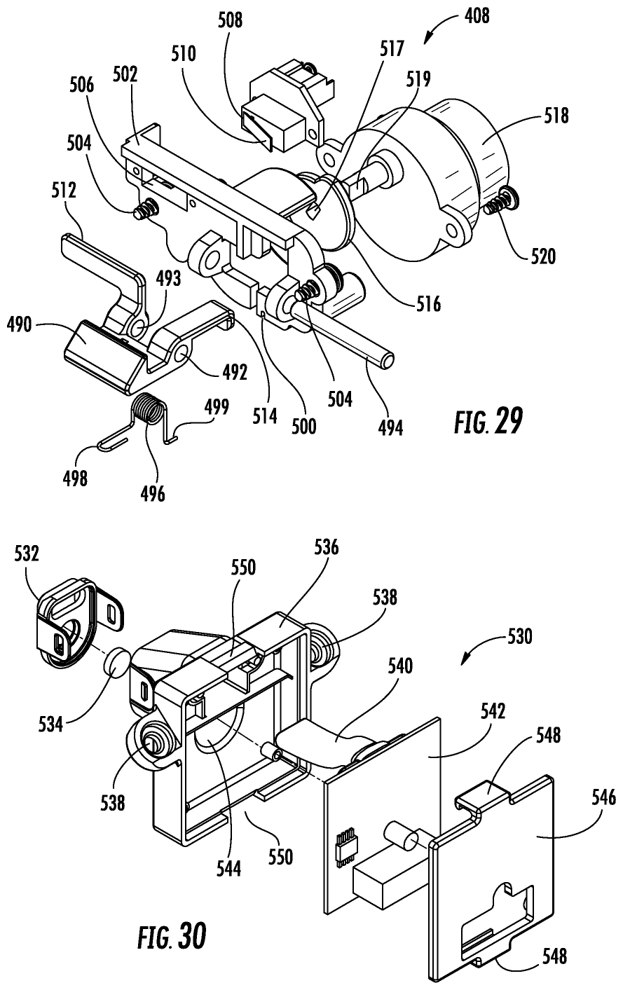

FIGS. 24-30, show a piston pod mechanism 400 that may be comprised of drawer assembly 402 (see FIG. 28), main frame 404, worm gear 406, drawer open/close module 408 (FIG. 29), motor housing 410, motor 412, worm 414, manifold assembly 416 (see FIG. 27), air pump 418, air pump housing 420, and top housing 422.

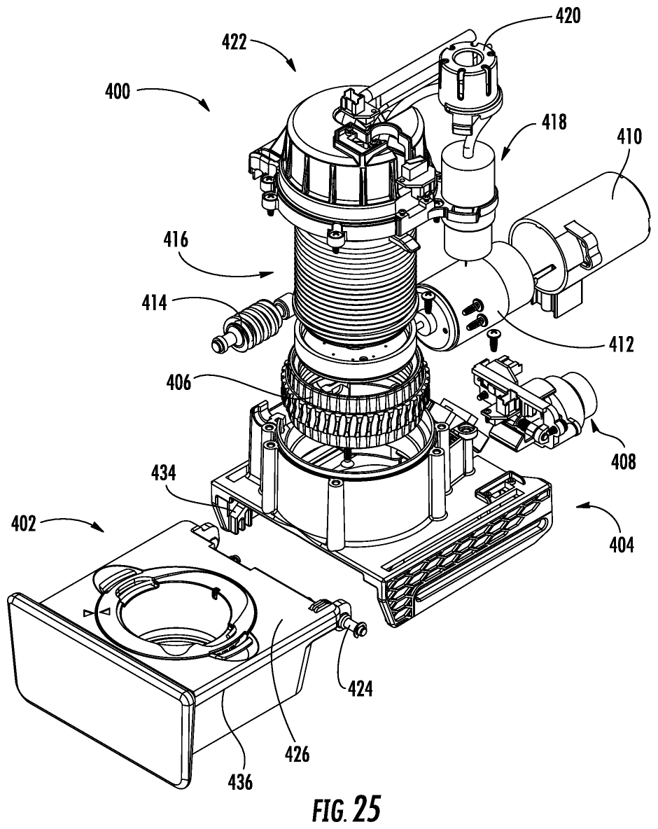

As shown in FIG. 25, drawer assembly 402 may be slidably engaged with main frame 404 such that drawer assembly 402 may slide into and out of main frame 404. Drawer assembly 402 may connect to cover 430 using dowel pin 424, which may be connected using heat molded plastic, slot and tab, or adhesive to drawer assembly frame 426. As shown in FIGS. 25 and 28, dowel pin 424 may be held into connection 428 of cover 430 with compression spring 425. Compression spring 428 may be compressed to allow dowel pin 424 to be removed from connection 428 and frame 426 may then be removed from cover 430.

Drawer assembly 402 may slide into and out of main frame 404. The assembly 402 may slidably engage with adapter 434 to attach to main frame 404. The lip 436 may engage with adapter 434, which may have a tapered cross section and be received within side decking grooves of the main frame 404. Lip 436 of cover 430 may then slide into and along the interior of main frame within the grooves on each side of the main frame 404.

Removable insert 440 may matingly engage with slot 442 in drawer assembly frame 426. Slot 442 may be configured with drawer assembly frame rim 444. Removable insert base lip 448 may rest on drawer assembly frame rim 444. Cup 450 may have standoffs 452 which may snap into tracks 454 on base 446. Removable insert compression spring 456 may fit between cup 450 and base 446. Spring 456 may rest on a lip in base 446.

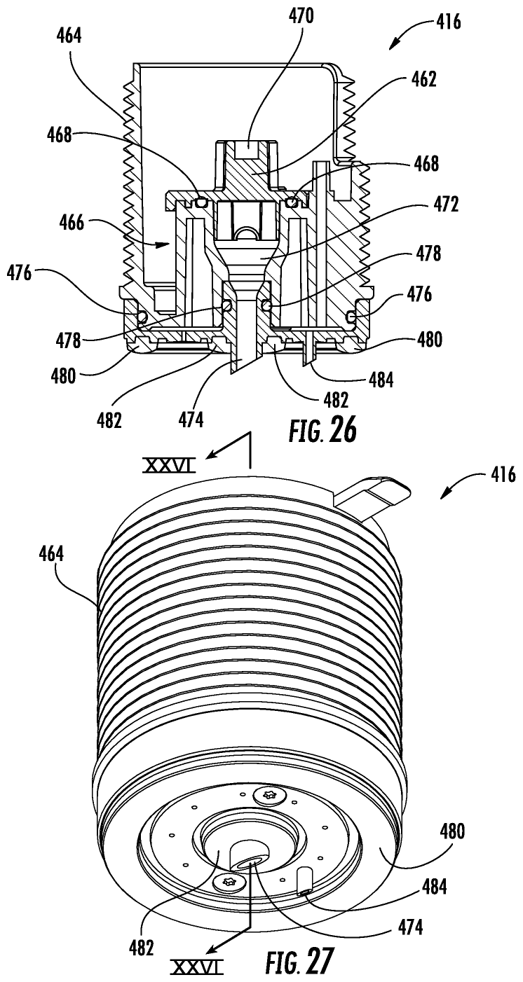

Manifold assembly 416 (FIGS. 26-27) may be located between top housing 422 and manifold interface 460. Manifold cover 462 may be located inside manifold shaft 464 and may seal to the fluid chamber assembly 466 with O-ring 468. Fluid feed line (not shown) may run into fluid feed line adapter 470 shown at top of manifold cover 462. Fluid feed line 568 (FIG. 24) may run through manifold cover 462 into funnel 472. A cutout (not shown) in fluid feed line 568 at the junction of fluid feed line 568 and funnel 472 may create a thrust vector which may bend the fluid flow path toward the center of water nozzle 474, which may connect to an outlet end of funnel 472.

Water nozzle 474 may protrude through manifold interface 460. Water nozzle 474 may have a sharp edge at the outlet end, which may facilitate tearing through top composite film 302, 352 of piston pod 300, 350. O-ring 476 may seal a connection between manifold shaft 464 and manifold interface 460. O-ring 478 may seal a connection between fluid chamber assembly 466 and manifold interface 460. Outer gasket 480 may seal a connection between manifold interface 460 and an outer perimeter of piston pod 300, 350, and inner gasket 482 may seal a connection between manifold interface 460 and an inner perimeter of piston pod 300, 350. Together, inner gasket 482 and outer gasket 480 create a leak free connection between manifold interface 460 and pod 300, 350. Air nozzle 484 may protrude through manifold interface 460. Air nozzle 484 may have a sharp edge at outlet end which may facilitate tearing through top composite film 302, 352 of piston pod 300, 350.

As shown in FIGS. 25 and 29, drawer open/close module 408 may connect to main frame 404 to facilitate automatic opening and closing of drawer assembly 402. Latch 490 may engage with drawer assembly frame 426 to lock drawer assembly 402 closed and to release drawer assembly 402 after the beverage is ready and piston pod mechanism 400 has completed a cycle and returned to safe operating state. First hole 492 and second hole 493 typically align with one another and are configured to fit over/receive dowel pin 494. Tension spring 496 may also fit over dowel pin 494 between first hole 492 and second hole 493. Flat loop 498 of tension spring 496 may rest on a bottom side of latch 490 and L-shape portion 499 of tension spring 496 may fit into the U-shaped mouse hole 500 on drawer open/close module frame 502 such that between flat loop 498 and L-shape portion 499, tension spring 496 remains static unless latch 490 rotates. Tension spring 496 may then return latch 490 into a home position when no other force, typically an external, user activated force is acting on latch 490.

Frame 502 may connect to main frame 404 with a fastener(s) such as screw(s) 504 or other fastening device or system. Slot 506 may provide a hole for a fourth microswitch 508. Trigger 510 may be depressed by latch arm 512 when latch 490 is in a home position. The latch may be rotated by rotation of eccentric cam 516, which may have cam slot 517 that may attach to second motor 518 via drive peg 519. Second motor 518 may attach to main frame 404 with screw(s) 520 and be configured to rotate eccentric cam 516.

Optical reader 530 (See FIG. 30) may connect to main frame 404 such that lens 534 may view an interior of piston pod mechanism 400 through front cover 532. Housing 536 may attach to main frame with screw(s) (not shown) through eyelets 538. Light pipe 540 may connect to printed circuit board 542 and pass through light pipe slot 544 in housing 536 to provide light to lens 534. Back cover 546 may close the content of optical reader from the outside. Back cover 546 may attach to housing 536 with latch(es) 548 on back cover 546, which engage(s) with latch snap(s) 550 on housing.

In operation, a user may load piston pod 300, 350 into removable insert 440 of drawer assembly 402. Removable insert 440 holds the pod in place. Spring loaded cup 450 keeps pod 300, 350 in place and prevent the bottom of pod 300, 350 from to engaging with base 446. Standoff(s) 452 and track(s) 454 allows cup 450 to traverse up and down slightly. The user may remove removable insert 440 from drawer assembly 402 by hand and without the use of tools by pinching side tab(s) 458 and that portion of removable insert 440 will disengage from drawer assembly 402 for cleaning, part replacement, etc.

The user may then close drawer assembly 402 into main frame 404. Drawer assembly 402 induces latch 490 to open when pushed into main frame 404 and becomes prevented from opening when it passes under latch 490. A third microswitch 566 may detect the presence or absence of drawer assembly 402 and send a signal to a controller to turn on optical reader 530 when drawer assembly 402 is closed into main frame 404. Optical reader 530 may scan drawer assembly 402 and pod 300, 350 and sends a signal to controller 576 to identify the beverage selection based upon a code and/or image on the pod 300, 350.

First motor 412 may be energized by the controller and drives manifold assembly 416 downwards until it closes microswitch 564, signifying manifold assembly 416 is in an away position. Then, manifold assembly interface 460 may act as a bridge between pod 300, 350 and piston pod mechanism 400. First motor 412 may force manifold assembly 416 to clamp pod 300, 350 in position with compressive force such that inner gasket 482 and outer gasket 480 establish a seal between pod 300, 350 and piston pod mechanism 400. Manifold interface may 460 make contact with the top of pod 300, 350 and water nozzle 474 may pierce top composite film 302, 352 thereby providing a channel between water nozzle 474 and, when present center column 306. Similarly, air nozzle 484 may pierce top composite film 302, 352 providing a channel between recessed pocket 356 and air nozzle 484.

Manifold assembly 416 may travel downwards, causing manifold interface 460 to press outer gasket 480 and inner gasket 482 against pod 300, 350, forming an airtight seal between interface 460 and pod 300, 350. Further compression by manifold assembly 416 may cause capsule cap 310 to cave towards capsule body 303. Spikes 316 on capsule cap 310 pierce bottom composite film 308 and create escape paths for concentrate inside of capsule body 303. Blowing air into pod 300, 350 causes increased pressure inside capsule body 303 and forces concentrate out through channels created by spikes 316 in bottom composite film 308.

When water is delivered, water flows from fluid feed line 568 through funnel 472 and water nozzle 474 through center column 306 of pod 300, 350. Water and concentrate mix in capsule cap 310 and beverage may flow out of piston pod mechanism 400.

When dispensing is complete, first motor 412 may be energized in reverse direction by the controller. Manifold interface 460 may disengage from capsule cap 310, causing capsule cap diaphragm to recoil back and returns to its original form. Manifold assembly 416 may retract until it returns to a “home” position. Manifold assembly 416 may trip first microswitch 562 closing the first microswitch 562 signifying manifold assembly 416 is in the home position.

When the dispensing sequence ends, the controller energizes second motor 518 releasing drawer assembly 402. Second motor 518 may turn eccentric cam 516 until latch 490 releases drawer assembly 402. Eccentric cam 516, driven by second motor 518, may start lifting latch 490 as eccentric cam 516 rotates. The eccentric profile of eccentric cam 516 enables second latch arm 514 to ride along eccentric cam 516 preventing latch 490 from hammering or suddenly opening or closing. Latch 490 rotates on dowel-pin 494 and slowly releases drawer assembly 402. Drawer assembly compression spring 425 decompresses and pushes drawer assembly 402 away from drawer open/close module 408. The latch may continue riding along eccentric cam 516 for one full revolution. When drawer open/close module cycle is complete, first latch arm 512 may close and trigger 510 of fourth microswitch 508 signals to the controller to shut down second motor 518.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within the described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure , and further it is to be understood that such concepts are intended to be covered by the following claims unless these claims by their language expressly state otherwise.

1-49. (canceled)

50. A single-serving beverage capsule comprising:
a capsule body having an interior space between an inside of the capsule body and a composite film, the composite film attached to the capsule body at a capsule body bottom perimeter to create a sealed composite film;
wherein the sealed composite film includes at least one weak point is located about a composite film perimeter and in substantially the same plane as the composite film, the at least one weak point configured to break under a pressure less than the pressure needed to break a non-weak point portion of the sealed composite film and open a flow channel without the use of a physical piercing member that allows a beverage concentrate to flow through at least one of the at least one weak points and into the interior space;
a capsule cap having an exterior side and an interior side and having a capsule cap perimeter that is substantially equal to a perimeter of the composite film and the perimeter of the capsule body, the capsule cap being attached to a bottom end of the capsule body with the composite film between the interior side of the capsule cap and the bottom end of the capsule body and having a flow channel directing to a flow channel outlet; and
a distributor engaged with the capsule cap and having a water inlet, the flow channel outlet and a beverage outlet attached to the bottom side of the capsule cap.

51. The capsule of claim 50, wherein the capsule body is filled with a liquid concentrate or suspension and a sole liquid concentrate or suspension delivery flowpath is through one or more broken weak points about the composite film perimeter from a liquid concentrate or suspension facing side of the composite film to a distributor facing side of the composite film and into the flow channel.

52. The capsule of claim 51, wherein the distributor is a distributor cap that comprises a mixing space where water and concentrate received from the capsule body mix before flowing out of the beverage outlet.

53. The capsule of claim 50, wherein the capsule body has a frustoconical shape and is filled with a liquid concentrate or suspension.

54. The capsule of claim 50, wherein the capsule body contains at least one ridge around the perimeter of the capsule.

55. The capsule of claim 54, wherein the ridge like features collapses under an external planar pressure, enabling the capsule body to compress to a flat shape.

56. The capsule of claim 50, wherein the at least one weak point is a plurality of weak points evenly spaced about the composite film perimeter.

57. The capsule of claim 56, wherein the plurality of weak points is four weak points.

58. The capsule of claim 50, wherein the at least one weak point is created by two opposing cutouts from the composite film.

59. The capsule of claim 58, wherein the cutouts are V-shaped or U-shaped cutouts.

60. The capsule of claim 50, wherein the beverage concentrate is within the capsule body and flows into the distributor only via the at least one weak point and around the perimeter after at least one of the at least one weak points are broken.

61. A single-serving beverage concentrate containing capsule comprising:
a capsule body having a first composite film attached to a top perimeter at a top end of the capsule body such that the first composite film is attached about on entirety of the top perimeter and a beverage concentrate is within the capsule body when the capsule is unused;
at least one weak point in an attachment interface of the first composite film and the top perimeter, wherein the at least one weak point is located about a perimeter of the first composite film and the at least one weak point is formed as a part of the first composite film and the at least one weak point is configured to break under pressure prior to at least one strong attachment area that has more radial surface area of the first composite film attached to the top perimeter than a radial surface area of the first composite film attached to the top perimeter that forms the at least one weak point; and
a capsule cap attached to a bottom perimeter of the capsule body.

62. A single-serving beverage capsule comprising:
a capsule body having a first composite film attached to a top perimeter at a top end of the capsule body and a second composite film attached to a bottom perimeter at a bottom end of the capsule body and a beverage concentrate is within an interior volume of the capsule body when the capsule is unused;
a flow channel located within the capsule body with an inlet end at the first composite film and an outlet end at the second composite film and disposed within the capsule body to provide a fluid flow path through the capsule; and
a capsule cap attached to the bottom perimeter of the capsule body having a fluid passage in fluid communication with the flow channel.

63. The capsule of claim 62, wherein the capsule body is filled with a liquid beverage concentrate.

64. The capsule of claim 63, wherein the capsule cap has at least one nozzle outlet for liquid concentrate to exit the capsule body.

65. The capsule of claim 62, wherein the second composite film has a cutout around the flow channel.

66. The capsule of claim 62, wherein the capsule body has a cylindrical shape.

67. The capsule of claim 62, wherein a water passage channel begins at the top end of the capsule body and extends through the bottom end of the capsule body, through the second composite film, and through the capsule cap.

68. The capsule of claim 62, wherein sharp edges are located along an inner perimeter of the capsule cap and not exposed to a user, the sharp edges configured to make incisions in the second composite film when a compression force is applied to the capsule.

69. The capsule of claim 68, wherein the capsule cap is matingly engaged with a beverage machine when the capsule is loaded into the beverage machine such that a bottom of the capsule cap flexes up causing the sharp edges to make incisions in the second composite film when a force is applied to the capsule.
